(19) United States
(12) Patent Application Publication
(10) Pub. No.: US 2018/0217753 A1
(43) Pub. Date: Aug. 2, 2018

(54) MEMORY SYSTEM AND CONTROL METHOD

(71) Applicant: Toshiba Memory Corporation, Minato-ku (JP)

(72) Inventor: Shinichiro Nakazumi, Kawasaki (JP)

(73) Assignee: Toshiba Memory Corporation, Minato-ku (JP)

(21) Appl. No.: 15/701,580

(22) Filed: Sep. 12, 2017

(30) Foreign Application Priority Data
Jan. 31, 2017 (JP) 2017-015530

(51) Int. Cl. G06F 3/06; G06F 12/02; G06F 12/10

(52) U.S. Cl. CPC G06F 3/064; G06F 3/0608; G06F 3/061; G06F 12/10; G06F 3/0644; G06F 3/0679; G06F 12/0246

(57) ABSTRACT

According to one embodiment, a memory system is connectable to a host. The memory system includes a nonvolatile memory and a controller circuitry. The nonvolatile memory includes a first block and a second block. Each of the first block and the second block includes a plurality of first unit areas. The controller circuitry sets each of a first number of first unit areas among the plurality of first unit areas included in the first block as a second unit area. The controller circuitry sets each of a second number of first unit areas among the plurality of first unit areas included in the second block as the second unit area. The controller circuitry correlates the second unit areas included in the first block and the second block with a plurality of logical addresses in a one-to-one correspondence manner.

### CROSS-REFERENCE TO RELATED APPLICATIONS

This application is based upon and claims the benefit of priority from Japanese Patent Application No. 2017-015530, filed on Jan. 31, 2017; the entire contents of which are incorporated herein by reference.

### FIELD

Embodiments described herein relate generally to a memory system and a control method.

### BACKGROUND

In the related art, an SSD including a NAND type flash memory (hereinafter referred to as a NAND memory) is known as a memory system. The NAND memory is an example of a nonvolatile memory.

An SSD exhibits maximum performance at a beginning of use. As writing of data to the SSD is repeated, performance decreases rapidly and then the performance becomes to be in a steady state. In order to efficiently evaluate performance in the steady state, it is necessary to shorten a time until the performance of the SSD is changed from a state of the beginning of use to the steady state.

### BRIEF DESCRIPTION OF THE DRAWINGS

FIG. 1 is a diagram illustrating an example of a configuration of a memory system according to a first embodiment;

FIG. 2 is a graph illustrating an example of a change in performance of a general memory system;

FIG. 3 is a diagram illustrating a change of a distribution of the numbers of valid clusters in the general memory system;

FIG. 4 is a diagram illustrating a functional configuration of a CPU;

FIG. 5 is a sequence diagram schematically illustrating an outline of the entire operation of the memory system according to the first embodiment;

FIG. 6 is a flowchart illustrating an operation of the memory system according to the first embodiment in a preconditioning mode;

FIG. 7 is a diagram illustrating a method of setting a first cluster and a second cluster in the first embodiment;

FIG. 8 is a graph illustrating an example of distributions of the numbers of valid clusters in a third state; and

FIG. 9 is a diagram illustrating an objective distribution which is calculated in a second embodiment.

### DETAILED DESCRIPTION

In general, according to one embodiment, a memory system is connectable to a host. The memory system includes a nonvolatile memory and a controller circuitry. The nonvolatile memory includes a first block and a second block. Each of the first block and the second block includes a plurality of first unit areas. The controller circuitry sets each of a first number of first unit areas among the plurality of first unit areas included in the first block as a second unit area. The controller circuitry sets each of a second number of first unit areas among the plurality of first unit areas included in the second block as the second unit area. The controller circuitry correlates the second unit areas included in the first block and the second block with a plurality of logical addresses in a one-to-one correspondence manner.

Hereinafter, a memory system and a control method according to embodiments will be described in detail with reference to the accompanying drawings. The invention is not limited to the embodiment.

### First Embodiment

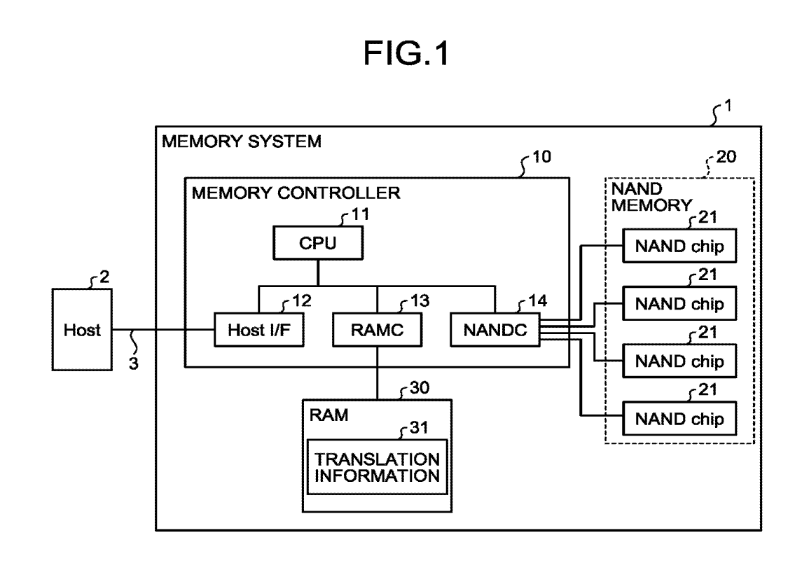

FIG. 1 is a diagram illustrating an example of a configuration of a memory system according to a first embodiment. The memory system 1 is connected to a host 2 via a communication channel 3. The host 2 is, for example, a computer or a server device. A computer includes a personal computer, a portable computer, or a portable communication device. The memory system 1 serves as an external storage device of the host 2. Any standard can be used as an interface standard of the communication channel 3.

The memory system 1 provides a logical address space which is a logical storage area for the host 2. Locations in the logical address space are specified by logical addresses. The capacity of the logical address space which is provided to the host 2 by the memory system 1 is referred to as a user capacity.

The host 2 can issue an access command (a writing command and a reading command) to the memory system 1. Each of access commands includes a logical address for designating a location to be accessed in the logical address space.

The memory system 1 includes a memory controller 10, a NAND type flash memory (NAND memory) 20 which is used as a storage, and a random access memory (RAM) 30. As the memory which is used as the storage, any kind of memory can be employed as long as it is a nonvolatile memory. For example, a NOR type flash memory, a resistance random access memory (ReRAM), or magnetoresistive random access memory (MRAM) can be employed. Any kind of memory can be employed as the RAM 30. For example, a dynamic random access memory (DRAM) or a static random access memory (SRAM) which is a volatile memory can be employed.

The NAND memory 20 includes one or more NAND chips 21 including a memory cell array. In the example illustrated in the drawing, the NAND memory 20 includes four NAND chips 21. Each memory cell array includes a plurality of physical blocks. All data stored in one physical block is erased collectively. Each physical block includes a plurality of physical pages. Writing and reading with respect to the NAND memory 20 are performed for each page.

A predetermined number of physical blocks may constitute one logical block and erasing of data may be performed for each logical block. A predetermined number of physical pages may constitute one logical page and writing and reading of data may be performed for each logical page. Hereinafter, a storage area which is a unit for erasing data is simply referred to as a block. A storage area which is a unit for writing and reading data is simply referred to as a page.

The memory controller 10 receives a command (an access command) from the host 2. The memory controller 10 performs data transmission between the host 2 and the NAND memory 20 in accordance with the received command. The memory controller 10 is an example of a controller circuitry of the embodiment.

The RAM 30 can serve as a buffer for data transmission between the host 2 and the NAND memory 20. The RAM 30 stores translation information 31. The translation information 31 is information for storing mapping of logical addresses to writing locations (physical addresses) where data are written in the NAND memory 20.

At the time of writing data sent from the host 2 to the NAND memory 20 or copying data within the NAND memory 20, mapping for the corresponding logical address is updated by updating the translation information 31. Specifically, by mapping the logical address to a new writing location, no logical address is mapped to a writing location (an old writing location) to which the logical address has been mapped before the updating. As a result, the host 2 can read data stored at the new writing location from the memory system 1, but cannot read data stored in the old writing location.

Hereinafter, a state of data which is stored at a location to which a logical address is mapped is referred to as “valid.” A state of data which is stored at a location to which no logical address is mapped is referred to as “invalid.”

In a logical address space, a unit for allocating a logical address and a unit which is managed by the translation information 31 may be equal to or different from each other. For example, it is assumed that a logical address is allocated for each area which is referred to as a sector and the translation information 31 is managed for each area which is referred to as a cluster having a size larger than a sector. A cluster includes a plurality of sectors of which logical addresses are continuous.

In the following description, each storage area in which data having a cluster size sent from the host 2 can be stored may be referred to as a cluster. Particularly, a cluster in the NAND memory 20 to which a logical address is mapped is referred to as a valid cluster, and a cluster in the NAND memory 20 to which no logical address is mapped is referred to as an invalid cluster.

So long as the translation information 31 can correlate the logical addresses with the physical addresses in a one-to-one correspondence manner, a data structure of the translation information 31 is not limited to any specific data structure. For example, the translation information 31 has a data structure in which physical addresses in units of a cluster are arranged in the order of the corresponding logical addresses. The translation information 31 may have a data structure in which logical addresses are arranged in the order of the corresponding physical addresses. The translation information 31 may include a multi-layered table. The entire translation information 31 may not be stored in the RAM 30. For example, a body of the translation information 31 may be stored in the NAND memory 20 and a part of the translation information 31 may be cached in the RAM 30.

The memory controller 10 includes a central processing unit (CPU) 11, a host interface (host I/F) 12, a RAM controller (RAMC) 13, and a NAND controller (NANDC) 14. The CPU 11, the host I/F 12, the RAMC 13, and the NANDC 14 are connected to each other via a bus.

The host I/F 12 controls the communication channel 3. The host I/F 12 receives a command from the host 2. The host I/F 12 performs data transmission between the host 2 and the RAM 30.

The RAMC 13 is a controller for causing the memory controller 10 to access the RAM 30.

The CPU 11 controls the memory controller 10 as a whole in accordance with a firmware program. The firmware program is stored, for example, in the NAND memory 20 in advance and the CPU 11 loads the firmware program from the NAND memory 20 to the RAM 30 at starting. The CPU 11 executes the firmware program stored in the RAM 30.

The NANDC 14 transmits a request corresponding to the command received from the CPU 11 to the NAND memory 20. The NANDC 14 performs data transmission between the RAM 30 and the NAND memory 20.

As described above, old data in the NAND memory 20 is invalidated by writing new data. Accordingly, in order to enable continuous writing, the memory system 1 requires a storage area with a capacity exceeding a user capacity. An excess of a capacity over the user capacity is referred to as an over-provisioning capacity.

When blocks corresponding to the over-provisioning capacity are used up, the memory controller 10 generates a writable block by erasing invalid data. Since it is rare that all data stored in one block is invalid, the memory controller 10 actually copies valid data remaining in a block to another block and then all data stored in the block as a copy source is erased or invalidated. A process of copying the valid data is referred to as garbage collection. A block which becomes to include no valid data by copying valid data is referred to as a free block.

When garbage collection is started, writing of data from the host 2 and writing due to copying of data occur in the NAND memory 20. The writing due to copying of data is different from the writing of data from the host 2. The writing of data due to copying of data decreases performance of the memory system 1.

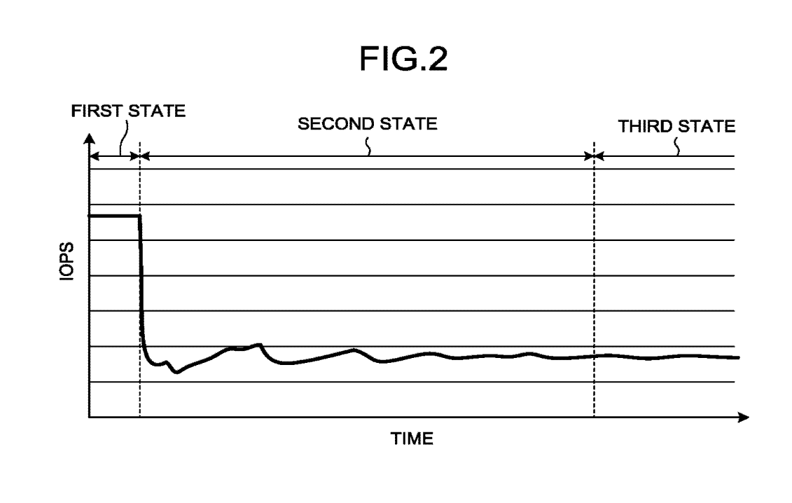

FIG. 2 is a graph illustrating an example of a change in performance of a general memory system. The vertical axis of the graph represents performance. In this example, performance means random writing performance and is expressed by input/output per second (IOPS). Random writing means that a plurality of writing commands which include logical addresses having little continuity are sequentially executed. The horizontal axis of the graph represents an elapsed time from the first-use time.

In a first-use state, since a large amount of free blocks are present, garbage collection is not performed. Accordingly, the memory system exhibits maximum performance. This state is referred to as a first state.

Thereafter, when all blocks corresponding to an over-provisioning capacity are filled with data, garbage collection is started. Accordingly, performance decreases rapidly and the performance is not stabilized for a while. This state is referred to as a second state.

Thereafter, a change of performance decreases with continuous writing for a while, and performance finally becomes constant. This state is referred to as a third state.

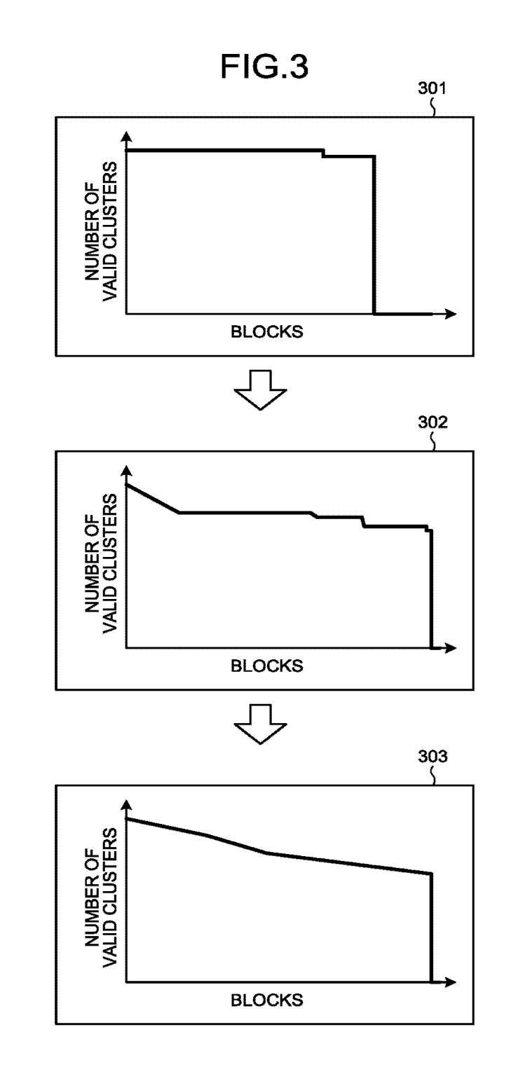

This transition of states is correlated with a change of distribution of the numbers of valid clusters. The distribution of the numbers of valid clusters is an arrangement which is composed of the numbers of valid clusters of individual blocks. FIG. 3 is a diagram illustrating a change of a distribution of the numbers of valid clusters in a general memory system. Here, the distribution of the numbers of valid clusters will be described as a distribution diagram in which the numbers of valid clusters included in the blocks are arranged sequentially from the largest.

In the drawing, a block which the number of valid blocks included in is zero represents a free block. In the first state, there are many free blocks as illustrated in a distribution diagram 301.

Garbage collection is performed in the second state or a state subsequent thereto. For example, the execution frequency of garbage collection is controlled such that the number of free blocks becomes a predetermined number which is satisfactorily small. That is, garbage collection can be performed when the number of free blocks is less than the predetermined number, and the garbage collection can be stopped when the number of free blocks is recovered to the predetermined number.

For a while after garbage collection is started, the distribution of the numbers of valid clusters is wavy as illustrated in a distribution diagram 302. In garbage collection, a block having the smallest number of valid clusters included therein is selected as a block of a copy source (hereinafter referred to as a source block) of valid data. When the distribution of the numbers of valid clusters is wavy, an amount of valid data to be copied varies whenever a new source block is set. As a result, the execution frequency of garbage collection varies temporally and performance becomes to be unsteady.

When writing is continuously performed, the distribution of the numbers of valid clusters of a plurality of blocks other than the free blocks approaches a linear shape as illustrated in a distribution diagram 303. In this case, since the amount of valid data to be copied becomes constant among the source blocks which are sequentially selected, the execution frequency of garbage collection becomes constant temporally and performance becomes to be steady. In the third state, the distribution of the numbers of valid clusters is in the state illustrated in the distribution diagram 303.

A process to be performed for measuring performance of a memory system in a steady state such as the third state is referred to as preconditioning. When preconditioning is performed by random writing from the host 2, it is necessary to perform random writing of an amount of data much exceeding a sum of a user capacity and an over-provisioning capacity. Therefore, a very long time is required.

In this embodiment, in order to shorten a time required for preconditioning, the memory system 1 can operate in a preconditioning mode in addition to a mode (hereinafter referred to as a normal mode) in which an access to the NAND memory 20 is performed based on an access command from the host 2 while performing garbage collection.

The preconditioning mode is a mode in which valid clusters and invalid clusters are artificially generated by determining mapping of logical addresses to physical addresses inside the memory system 1. In the preconditioning mode, the memory controller 10 sets each cluster of a block as a first cluster or a second cluster, correlates the physical address of the first cluster with a logical address, and does not correlate the physical address of the second cluster with a logical address. Accordingly, the first cluster becomes to be regarded as a valid cluster and the second cluster becomes to be regarded as an invalid cluster.

In the preconditioning mode, data which is internally generated instead of data sent from the host 2 is stored in the clusters. Data stored in each cluster is not limited to specific data. Data stored in each cluster may be, for example, all “1”. That is, in the preconditioning mode, writing of data from the host 2 is not necessary. In the preconditioning mode, garbage collection is not performed. Data written to the NAND memory 20 in the preconditioning mode is referred to as dummy data.

In the preconditioning mode, the memory controller 10 generates translation information 31 such that the distribution of the numbers of valid clusters becomes the distribution illustrated in the distribution diagram 303. When the memory system 1 transits from the preconditioning mode to the normal mode after the translation information 31 is generated in the preconditioning mode, the memory system 1 can exhibit performance in the third state immediately after the transition.

In the preconditioning mode, dummy data is written to the NAND memory 20 in all areas with a sum of the user capacity and the over-provisioning capacity. Accordingly, in comparison with a case in which preconditioning is performed by repeating random writing, a time required until the third state is realized is shortened.

When random writing is repeatedly performed, physical addresses on which a plurality of continuous logical addresses are mapped tend to be discontinuous and invalid clusters are likely to be generated at random locations in each block. In the preconditioning mode, the memory controller 10 maps a plurality of continuous logical addresses to a plurality of physical addresses which are not as continuous as possible such that the translation information 31 becomes a state similar to the state after random writing is repeatedly performed. The memory controller 10 disperses invalid clusters as uniform as possible in each block.

In the preconditioning mode, an objective distribution of the numbers of valid clusters in the third state can be internally generated or may be set from the outside. In the first embodiment, the objective distribution of the numbers of valid clusters is input from the outside (for example, the host 2). Hereinafter, the objective distribution of the numbers of valid clusters is referred to as an objective distribution.

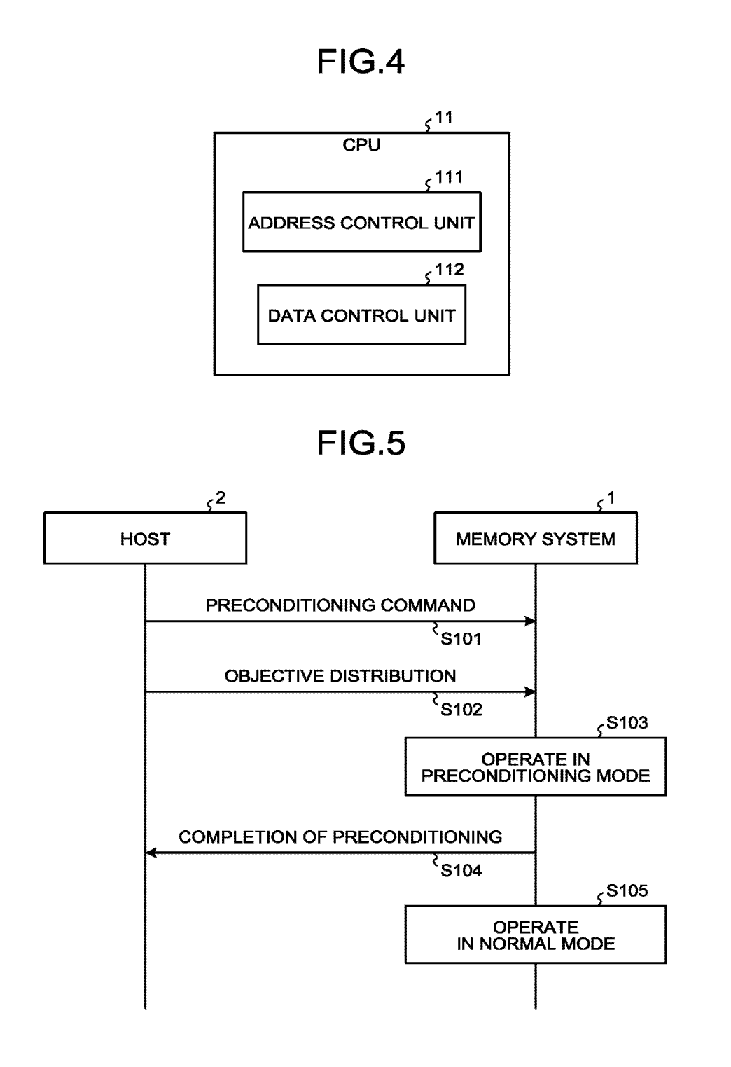

FIG. 4 is a diagram illustrating a functional configuration of the CPU 11 according to the first embodiment. The CPU 11 serves as an address control unit 111 and a data control unit 112 by executing a firmware program.

The address control unit 111 generates translation information 31 in the preconditioning mode. The address control unit 111, in the normal mode, updates and refers to the translation information 31.

The data control unit 112, in the normal mode, performs data transmission in response to an access command from the host 2 and copying of data between blocks due to garbage collection. The data control unit 112 performs writing dummy data to the NAND memory 20 in the preconditioning mode.

The operation of the memory system 1 according to the first embodiment will be described below.

FIG. 5 is a sequence diagram illustrating an outline of operations of the memory system 1 and the host 2 according to the first embodiment. First, the host 2 transmits a preconditioning command to the memory system 1 (S101). The preconditioning command is a command for starting the preconditioning mode. The preconditioning command may be a dedicated command independent of other commands or may be prepared as a command option of an existing command. For example, the preconditioning command may be prepared as a command option of a format command.

Subsequent to the process of S101, the host 2 transmits an objective distribution to the memory system 1 (S102).

The objective distribution may have a data structure which is expressed by a sequence of the numbers of valid clusters or may have a data structure of a function. The host 2 may acquire a distribution of the numbers of valid clusters from another memory system in which preconditioning has been completed in advance and may use the acquired distribution of the numbers of valid clusters distribution as the objective distribution. In the other memory system, for example, preconditioning may be performed by repeating random writing. The objective distribution may be calculated or experimentally acquired and stored in the host 2 in advance.

When the preconditioning command and the objective distribution are received from the host 2, the memory system 1 starts operation in the preconditioning mode (S103). As described above, in the preconditioning mode, execution of garbage collection is prohibited and the access command is not processed.

When the operation in the preconditioning mode is completed, the memory system 1 notifies the host 2 that preconditioning is completed (S104). Then, the memory system 1 transits from the preconditioning mode to the normal mode (S105). In the normal mode, the memory system 1 can perform processing of the access command and the garbage collection. The memory system 1 can exhibit performance in the third state after the transition to the normal mode. Accordingly, when notification of completion is received, the host 2 can immediately measure performance in the third state.

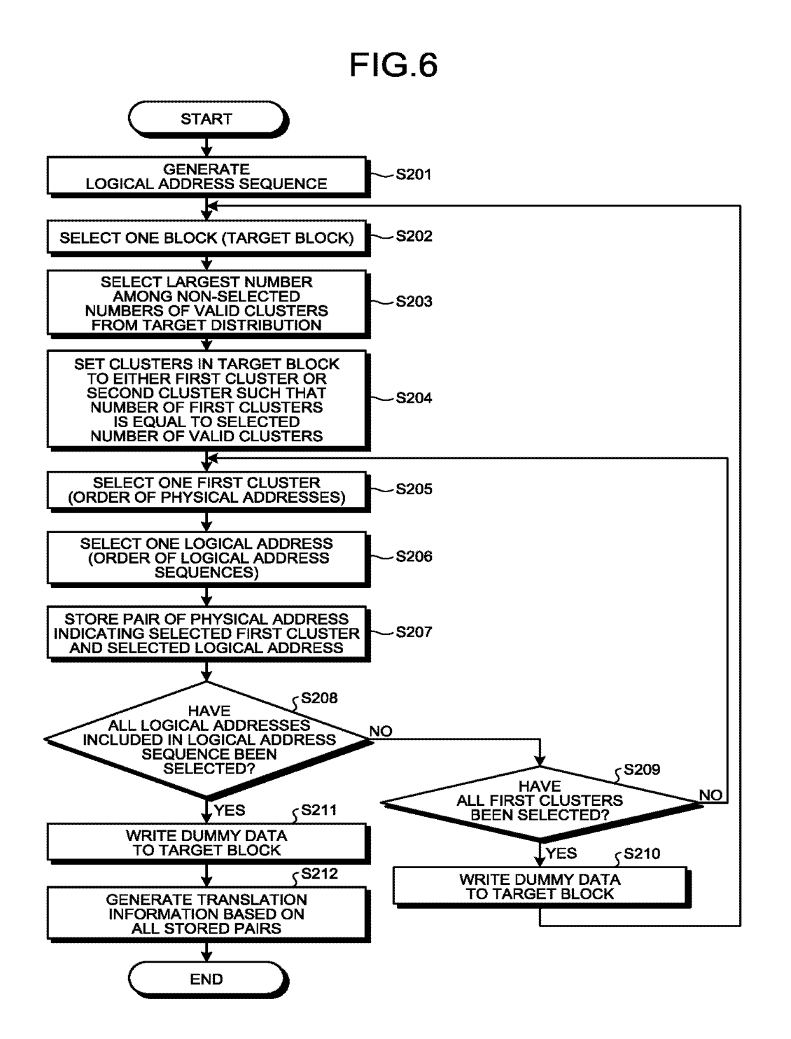

FIG. 6 is a flowchart illustrating an operation in the preconditioning mode of the memory system 1 according to the first embodiment.

First, the address control unit 111 generates a logical address sequence (S201). The logical address sequence is a sequence of logical addresses of all the clusters in the logical address space. In the logical address sequence, the logical addresses of all the clusters are arranged as randomly as possible and duplication of the same logical address is prohibited.

For example, the address control unit 111 generates the logical address sequence using the following Expression (1).

LA_i=(i−(i mod Nb)) /Nb+(Nt−(Nt mod Nb))/Nb*(i mod Nb) (1)

Here, LA_i denotes an i-th element from the head of the logical address sequence. Nt denotes the total number of clusters included in the logical address space. Nb denotes the total number of clusters included in one block.

An algorithm for generating the logical address sequence is not limited to the above-mentioned example. For example, the address control unit 111 may generate the logical address sequence in which logical addresses corresponding of all clusters in the logical address space are randomly arranged using a random number generator.

Referring to FIG. 6 again, subsequent to the process of S201, the address control unit 111 performs a process of allocating logical addresses to clusters. For example, this process is performed for each block.

First, the address control unit 111 selects one block (hereinafter referred to as a target block) (S202). S202 to S210 constitute a loop process which is performed for each block. At the first time of the loop process, a target block may be selected based on any criterion. At the second time of the loop process and subsequent loops thereto, each target block is selected among blocks which are not selected yet as the target block.

Subsequently, the address control unit 111 selects one of the number of valid clusters from the objective distribution (S203). For example, the address control unit 111 selects the largest number among the numbers of valid clusters which are not selected yet.

The address control unit 111 sets each of all clusters included in the target block to either a first cluster or a second cluster such that the number of first clusters is equal to the selected number of valid clusters (S204).

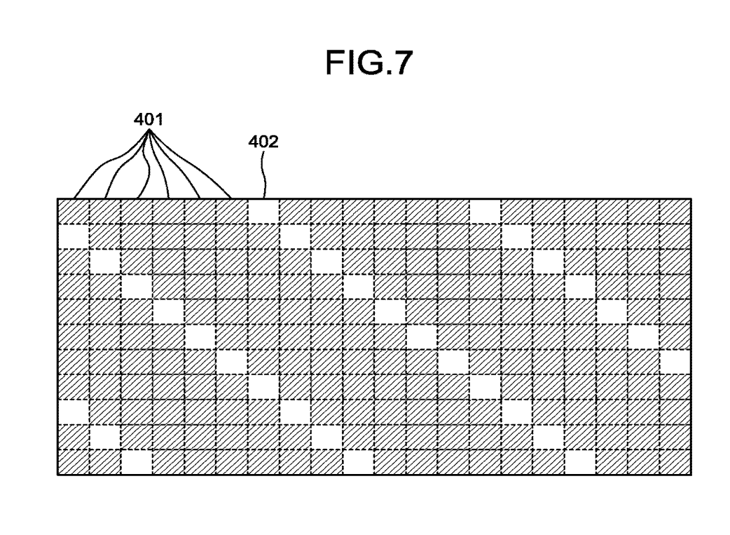

For example, the address control unit 111 disperses the first clusters in each block as uniformly as possible. FIG. 7 is a diagram illustrating a method of setting the first cluster and the second cluster in the first embodiment. The drawing illustrates a sequence of a physical address order of clusters in one block. In each row, the physical addresses increase in an ascending order to the right side in the drawing. A physical address of the cluster at the left end of a row is subsequent to a physical address of the cluster at the right end of a one-up row.

A hatched rectangle 401 denotes the first cluster and an outlined rectangle 402 denotes the second cluster. For example, when the number of clusters included in a block is 140,000 and the number of first clusters is 120,000, the address control unit 111 sets six clusters of which the physical addresses are continuous as first clusters and sets one cluster subsequent thereto as the second cluster as illustrated in the drawing. Accordingly, the first clusters and the second clusters are uniformly dispersed in the target block.

Subsequent to the process of S204, the address control unit 111 selects one first cluster in the target block (S205) and selects one logical address (S206). Then, the address control unit 111 stores the physical address indicating the selected first cluster and the selected logical address as a pair (S207). For example, the address control unit 111 prepares a temporary file in the RAM 30 and records the pair in the file in an appending manner. The data structure of the file is not limited to a specific data structure. For example, the file may have a data structure of a table.

In the process of S205, the address control unit 111 selects one first cluster in the order of physical addresses among a plurality of first clusters which have not been selected in the target block. In the process of S206, the address control unit 111 selects one logical address in the arrangement order in the logical address sequence from the non-selected logical addresses in the logical address sequence.

Subsequently, the address control unit 111 determines whether all the logical addresses included in the logical address sequence have been selected (S208). When a non-selected logical address remains in the logical address sequence (S208, No), the address control unit 111 determines whether all the first clusters in the target block have been selected (S209). When a non-selected first cluster remains in the target block (S209, No), the process of S205 is performed again.

When all the first clusters in the target block have been selected (S209, Yes), the data control unit 112 writes dummy data to at least all the first clusters in the target block (S210). After the process of S210, the process of S202 is performed again. The data control unit 112 may not write dummy data to the second clusters.

When all the logical addresses included in the logical address sequence have been selected (S208, Yes), the data control unit 112 writes dummy data to at least all the first clusters in the target block (S211). In S210 and S211, for example, the data control unit 112 performs writing of dummy data from a head page in the target block to a page including the finally selected first cluster. Also in S211, the data control unit 112 may not write dummy data to the second clusters.

Then, the address control unit 111 generates translation information 31 based on all the pairs which are stored (S212). For example, when the data structure of the translation information 31 is a lookup table for converting a logical address into a physical address, the address control unit 111 can generate the translation information 31 by sorting the pairs in the order of logical addresses.

In the above-mentioned example, the address control unit 111 generates a sequence in which logical addresses are randomly arranged to correlate a plurality of continuous logical addresses with a plurality of discontinuous physical addresses, and correlates the plurality of continuous physical addresses with elements of the sequence in the order in the sequence. An algorithm for correlating the plurality of continuous logical addresses with the plurality of discontinuous physical addresses is not limited thereto.

In this way, according to the first embodiment, the address control unit 111 selects the number of first clusters (valid clusters) for each of a plurality of blocks (S203 in FIG. 6). The plurality of blocks are at least two blocks. The address control unit 111 sets the selected number of first clusters for each of the plurality of blocks (S204 in FIG. 6). Then, the address control unit 111 correlates the plurality of logical addresses with the set first clusters in a one-to-one correspondence manner. Accordingly, since the memory system 1 can realize a valid cluster distribution of the distribution diagram 303 without repeatedly performing random writing, it is possible to shorten a time required for preconditioning. In other words, it is possible to efficiently evaluate performance.

The address control unit 111 generates the translation information 31 indicating correspondence between a plurality of logical addresses and the first clusters. Accordingly, the address control unit 111 can process an access command from the host 2 using the translation information 31. In the normal mode, that is, after the translation information 31 is generated, the address control unit 111 refers to or updates the translation information 31 in response to the access command from the host 2.

The address control unit 111 starts generating of the translation information 31 in response to the objective distribution and the preconditioning command received from the host 2 (S101 to S103 in FIG. 5). Accordingly, it is possible to control the preconditioning operation from the host 2.

The objective distribution is information indicating the number of valid clusters for each block and is information which is acquired from another memory system. Since the distribution of the numbers of valid clusters acquired from a memory system subjected to preconditioning can be used as an objective distribution, it is possible to improve performance evaluation efficiency in a case where performance of a plurality of memory systems is to be evaluated.

The address control unit 111 arranges a plurality of logical addresses randomly or pseudo-randomly (S201 in FIG. 6) and correlates the plurality of logical addresses with the first clusters in the arranged order (S205 to S209 in FIG. 6, No).

The logical address sequence may be generated in advance by another computer and may be sent to the memory system 1. For example, the memory system 1 may receive the logical address sequence along with the preconditioning command and the objective distribution from the host 2.

The address control unit 111 uniformly disperses the first clusters in a block (S204 in FIG. 6). Accordingly, the state of the translation information 31 can be set to be similar to a state after random writing is repeatedly performed. That is, the translation information 31 can be set to be similar to the state after random writing is repeatedly performed.

The data control unit 112 writes dummy data to the blocks (S210 and S211 in FIG. 6). Accordingly, the memory system 1 can transmit dummy data to the host 2 in response to a reading command after the transition to the normal mode. The data control unit 112 may not write dummy data to the second clusters (invalid clusters).

### Second Embodiment

In the first embodiment, an example in which the host 2 transmits an objective distribution to the memory system 1 has been described above. In a second embodiment, an example in which the memory system 1 calculates an objective distribution therein will be described below.

When the user capacity is fixed, the distribution of the numbers of valid clusters in the third state varies depending on an over-provisioned percentage. The over-provisioned percentage is a value which is acquired by dividing the over-provisioning capacity by the user capacity.

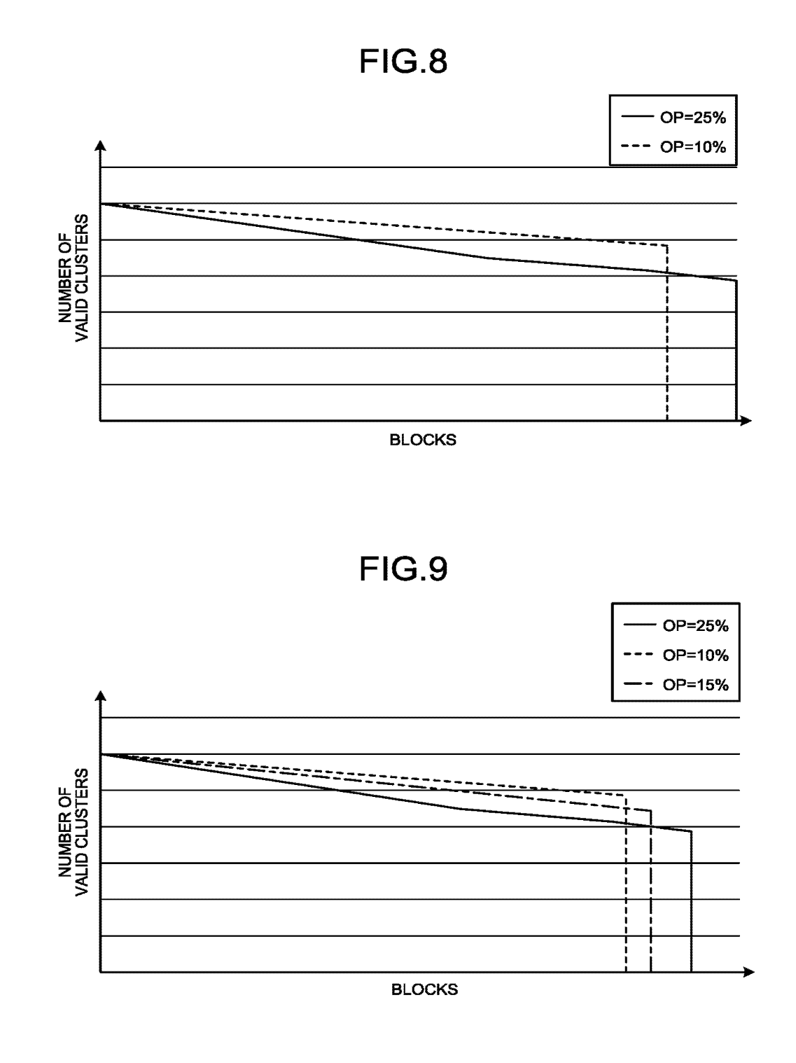

FIG. 8 is a graph illustrating an example of distributions of the numbers of valid clusters in the third state. In the drawing, a distribution of the numbers of valid clusters with an over-provisioned percentage of 10% and a distribution of the numbers of valid clusters with an over-provisioned percentage of 25% are illustrated. In the case where the over-provisioned percentage is 25%, the slope of the distribution of the numbers of valid clusters is larger than the case in which the over-provisioned percentage is 10%. This is because as the over-provisioned percentage increases, the number of blocks available increases.

In the second embodiment, the address control unit 111 calculates the objective distribution based on two distribution of the numbers of valid clusters and the over-provisioned percentage of the memory system 1. An example of a method of calculating the objective distribution will be described below. The two distribution of the numbers of valid clusters which are used to calculate the objective distribution are referred to as model distributions.

One (a first model distribution) of two model distributions which have been prepared in advance is a distribution of the numbers of valid clusters in the case in which the over-provisioned percentage is OP1, and the other (a second model distribution) is a distribution of the numbers of valid clusters in the case in which the over-provisioned percentage is OP2. Here, it is assumed that OP1 is greater than OP2.

The model distributions and the objective distribution are approximated by the following linear expression.

y=−A*x+B (2)

When the over-provisioned percentage of the memory system 1 is defined as OPt, the slope A of the first model distribution is defined as A1, the y-intercept B of the first model distribution is defined as B1, the slope A of the second model distribution is defined as A2, and the y-intercept B of the second model distribution is defined as B2, the address control unit 111 calculates the slope At of the objective distribution and the y-intercept Bt of the objective distribution using the following Expressions (3) and (4).

At=A1+|A1−A2|*((OP1−OPt)/(OP1−OP2)) (3)

Bt=B1−(B1−B2)*((OP1−OPt)/(OP1−OP2)) (4)

FIG. 9 is a diagram illustrating the objective distribution calculated in the second embodiment. In the example illustrated in FIG. 9, a model distribution when the over-provisioned percentage of the memory system 1 is 15% is calculated from the model distribution when the over-provisioned percentage is 10% and the model distribution when the over-provisioned percentage is 25%.

The address control unit 111 may acquire two model distributions each expressed by a combination of the slope and the y-intercept or may acquire two model distributions expressed by arrangements of the numbers of valid clusters. In the latter case, the address control unit 111 calculates the slope and the y-intercept by approximating the distribution of the numbers of valid clusters using the linear expression of Expression (2).

The two model distributions may be sent from the host 2 to the memory system 1 along with the preconditioning command, or may be stored in the NAND memory 20 or the like in advance. The address control unit 111 calculates the objective distribution, for example, before the loop process of S202 to S210 in FIG. 6 is started.

As described above, according to the second embodiment, the address control unit 111 calculates an objective distribution based on two model distributions correlated with different over-provisioned percentages and an over-provisioned percentage of the own memory system 1. Since the objective distribution of any over-provisioned percentage can be calculated from the two model distributions, it is not necessary to prepare an objective distribution for each memory system 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system that is connectable to a host, the memory system comprising:
a nonvolatile memory that includes a first block and a second block, each of the first block and the second block including a plurality of first unit areas; and
a controller circuitry that sets each of a first number of first unit areas among the plurality of first unit areas included in the first block as a second unit area, sets each of a second number of first unit areas among the plurality of first unit areas included in the second block as the second unit area, and correlates the second unit areas included in the first block and the second block with a plurality of logical addresses in a one-to-one correspondence manner.

2. The memory system according to claim 1, wherein the controller circuitry generates translation information indicating correspondence between the plurality of logical addresses and the plurality of second unit areas included in the first block and the second block.

3. The memory system according to claim 1, wherein the controller circuitry receives distribution information indicating the first number and the second number from the host.

4. The memory system according to claim 3, wherein the distribution information is information indicating the number of second unit areas correlated with the logical addresses for each of the first block and the second block.

5. The memory system according to claim 4, wherein the controller circuitry determines the first number and the second number based on at least two pieces of distribution information correlated with different over-provisioned percentages and an over-provisioned percentage of the memory system.

6. The memory system according to claim 1, wherein the controller circuitry arranges the plurality of logical addresses randomly or pseudo-randomly and correlates the plurality of logical addresses with the second unit areas included in the first block and the second block in an arrangement order of the logical addresses.

7. The memory system according to claim 1, wherein the controller circuitry receives sequence information in which the plurality of logical addresses are randomly or pseudo-randomly arranged from the host and correlates the plurality of logical addresses with the second unit areas included in the first block and the second block in an arrangement order in the sequence information.

8. The memory system according to claim 1, wherein the controller circuitry uniformly disperses the second unit areas in the first block and the second block.

9. The memory system according to claim 1, wherein the controller circuitry writes data which is not received from the host into at least the second units areas included in the first block and the second block.

10. The memory system according to claim 2, wherein the controller circuitry refers to or updates the translation information in response to an access command from the host after generating the translation information.

11. A method of controlling nonvolatile memory in a memory system including a nonvolatile memory that includes a first block and a second block, each of the first block and the second block including a plurality of first unit areas, the method comprising:
setting each of a first number of first unit areas among the plurality of first unit areas included in the first block as a second unit area;
setting each of a second number of first unit areas among the plurality of first unit areas included in the second block as the second unit area; and
correlating the second unit areas included in the first block and the second block with a plurality of logical addresses in a one-to-one correspondence manner.

12. The method according to claim 11, further comprising generating translation information indicating correspondence between the plurality of logical addresses and the plurality of second unit areas included in the first block and the second block.

13. The method according to claim 11, further comprising receiving distribution information indicating the first number and the second number from the host.

14. The method according to claim 13, wherein the distribution information is information indicating the number of second unit areas correlated with the logical addresses for each of the first block and the second block.

15. The method according to claim 14, further comprising receiving at least two pieces of distribution information correlated with different over-provisioned percentages from the host and determining the first number and the second number based on the received two pieces of distribution information and an over-provisioned percentage of the memory system.

16. The method according to claim 11, further comprising arranging the plurality of logical addresses randomly or pseudo-randomly and correlating the plurality of logical addresses with the second unit areas included in the first block and the second block in an arrangement order of the logical addresses.

17. The method according to claim 11, further comprising receiving sequence information in which the plurality of logical addresses are randomly or pseudo-randomly arranged from the host and correlating the plurality of logical addresses with the second unit areas included in the first block and the second block in an arrangement order of the sequence information.

18. The method according to claim 11, further comprising:
uniformly dispersing the second unit areas in the first block; and
uniformly dispersing the second unit areas in the second block.

19. The method according to claim 11, further comprising writing data which is not received from the host into at least the second units areas included in the first block and the second block.

20. A memory system comprising:
a nonvolatile memory that includes a first block and a second block, each of the first block and the second block including a plurality of first unit areas; and
a controller circuitry that correlates a first number of first unit areas among the plurality of first unit areas included in the first block and a second number of first unit areas among the plurality of first unit areas included in the second block with a plurality of logical addresses which is able to be designated by a writing command from an outside of the memory system in a one-to-one correspondence manner without using the writing command from the outside.
